(19) United States
(12) Patent Application Publication
(10) Pub. No.: US 2009/0239598 A1
(43) Pub. Date: Sep. 24, 2009

(54) GAMING SYSTEM ENABLING TO BET ON ANY TEAM FORMED WITH A PREDETERMINED NUMBER OF CHARACTERS APPEARED IN A RACING GAME IN WHICH A PREDETERMINED NUMBER OF RACES ARE PLAYED AS A SET, GAMING MACHINE, AND GAME CONTROL METHOD

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/235,974

(22) Filed: Sep. 23, 2008

Related U.S. Application Data
(60) Provisional application No. 61/034,375, filed on Mar. 6, 2008.

(51) Int. Cl. A63F 9/24; A63F 13/00

(52) U.S. Cl. 463/6; 463/30; 463/42

(57) ABSTRACT

A racing game is provided in which a main controller 20 accepts bets on teams in addition to bets on characters participating in each race, from a plurality of terminal devices 30, for a predetermined plurality of racing games. After the predetermined plurality of races, the main controller 20 computes payouts for bets on teams and provides an award.

### CROSS REFERENCE TO RELATED APPLICATIONS

This application claims benefit of U.S. Provisional Application No. 61/034,375, filed Mar. 6, 2008, the entire contents of which are incorporated herein by reference.

### BACKGROUND OF THE INVENTION

1. Field of the Invention

The present invention relates to a gaming system, a gaming machine and a game control method that forms a team of a predetermined number of characters on which a player can bet, in a racing game in which a plurality of races in a set is performed.

2. Related Art

Conventionally, racing games are known in which a plurality of characters races, a player bets by predicting the finishing order, and the player is awarded based on the rank of the bet character and an odds announced before the start of the race. A representative example of such racing games is a game in which the racing character is a horse, such as a horse racing game disclosed in U.S. Pat. No. 5,320,351. The racing character can be a car, other animals and the like; however, the player bets similarly by predicting the finishing order thereof.

The target of a bet can be, in a horse racing game such as the one illustrated in U.S. Pat. No. 6,848,991: a horse of first place; horses of first and second places; a group of a predetermined number of horses including horses of first and second places; and the like. Thus, in almost all the horse racing games, being the same as horse racing of the real world.

In such a case, the ability of a certain character often determines winning and losing, as well as a bet result. For example, an individual configured to be “strong” likely wins the race. Betting on the “strong” individual character can make the probability of winning high; however, the odds thereof becomes low due to a high number of bets thereon, which results in a low payout. Therefore, to earn a high payout, a player must bet on an individual character having a lower probability of winning, and wait for it to win. On the contrary, in a case where all the characters are configured to have the same ability, it is extremely difficult to predict and win the bet due to a lack of clues, which may deter the players.

In order to solve the aforementioned problem, the present invention provides a gaming system, a gaming machine and a game control method as a racing game in which a predetermined number of races in a set takes place and a player can, in addition to bet based on a certain individual among a plurality of characters participating in a race, bet on a team constituted of a predetermined number of characters, thus providing a various betting options and increasing the chance to win the bet, to arouse interest and excitement of the player.

### SUMMARY OF THE INVENTION

In a first aspect of the present invention, a gaming system includes: a display for displaying images related to a racing game in which a set of a predetermined number of races is executed; first memory for storing a plurality of teams constituted of a predetermined plurality of characters which participates in at least any one of the predetermined number of races and is a target of a bet; a plurality of terminals comprising an input device for accepting at least any one of: a first bet which is a bet on any one of a plurality of the teams; a second bet which is a bet on characters in each of the predetermined number of races; and a third bet which is a bet on a series of the plurality of teams, designating finishing places thereof after the predetermined number of races, and input a bet amount; second memory for storing, for each of the plurality of terminals, at least any one of the first bet, the second bet, and the third bet, and the bet amount; third memory for storing, for each of a plurality of the teams, a score provided to each member of each of a plurality of the teams; a controller for executing the predetermined number of racing games; a communication network device for allowing intercommunication between the plurality of terminals and the controller, in which the controller executes the following processing of: (a) receiving at least any one of the first bet, the second bet and the third bet, and the bet amount from the plurality of terminals and storing thereof in the second memory; (b) after the end of each of the predetermined number of races, determining a score corresponding to a finishing order of the plurality of characters participating in the race, and storing the score in the third memory for each of the plurality of teams; (c) after the predetermined number of races, determining ranking of the teams based on a total score for each of the plurality of teams stored by the processing (b); and (d) providing an award based on: a ranking of the plurality of characters; a ranking of the teams determined in the processing (c); and a bet type and the bet amount of each of the plurality of terminals.

In the first aspect of the present invention, a controller of the gaming system executes a racing game in which a predetermined number of races in a set take place. Teams constituted of a predetermined plurality of characters participating in at least any one of the predetermined number of races are stored in the first memory, which can be selected as a target of a bet by a player using the input device. In other words, a player can bet on a team expected to be a final winner of a plurality of races in a set. A bet can be selected from: a first bet which is a bet on any one of the plurality of team; a second bet which is a bet on characters in each of the predetermined number of races; and a third bet which is a bet on a series of the teams, designating finishing places thereof after the predetermined number of races. After receiving the bets from the plurality of terminals, the controller stores the bet kind and the bet amount in the second memory. Then the controller executes a race and tallies the result thereof. In other words, the controller provides score to each of the plurality of characters corresponding to the ranking thereof, and accumulates score for each of the teams. Then, the controller determines the ranking of the teams based on the accumulated score for each race after a set of races, and provides award depending on the bet kind and the bet amount made by each of the plurality of terminals, based on at least any one of the ranking of each of the plurality of characters in each race and the ranking of each of the plurality of teams.

In a second aspect of the present invention, a gaming system is provided, including: a display for displaying images related to a racing game in which a set of a predetermined number of races is executed; first memory for storing a plurality of teams constituted of a predetermined plurality of characters which participate in at least any one of the predetermined number of races and is a target of a bet; a plurality of terminals comprising an input device for accepting at least any one of: a first bet which is a bet on any one of the plurality of the teams; a second bet which is a bet on characters in each of the predetermined number of races; and a third bet which is a bet on a series of the teams, designating finishing places thereof after the predetermined number of races, and input a bet amount; second memory for storing, for each of the plurality of terminals, at least any one of the first bet, the second bet, and the third bet, and the bet amount; third memory for storing, for each of a plurality of the teams, a score provided to the plurality of the teams; a controller for executing the predetermined number of racing games; a communication network device for allowing intercommunication between the plurality of terminals and the controller, in which the controller executes the following processing of: (a) selecting a plurality of teams from the plurality of teams stored in the first memory, to show as options in the racing game; (b) displaying the plurality of characters and the plurality of the teams selected in the processing (a) on the display; (c) receiving at least any one of the first bet, the second bet and the third bet, and the bet amount from the plurality of terminals and storing the same in the second memory; (d) after the end of each of the predetermined number of races, determining a score corresponding to a finishing order of the plurality of characters participating in the race, and storing the score in the third memory for each of the plurality of the teams; (e) after the predetermined number of races, determining ranking of the teams based on the total score for each of the plurality of the teams stored by the processing (d); and (f) providing an award based on: a ranking of the plurality of characters; a ranking of a plurality of the teams determined in the processing (e); and a bet type and the bet amount of each of the plurality of terminals.

In the second aspect of the present invention, a controller of the gaming system executes a racing game in which a predetermined number of races in a set take place. Teams constituted of a predetermined plurality of characters participating in at least any one of the predetermined number of races are stored in the first memory in advance, which can be selected as options for betting, before a player makes a bet, and shown on a display. A player can select a team as target of a bet, using the input device. In other words, a player can bet on a team expected to be a final winner of a plurality of races in a set. A bet can be selected from: a first bet which is a bet on any one of the plurality of team; a second bet which is a bet on characters in each of the predetermined number of races; and a third bet which is a bet on a series of the teams, designating finishing places thereof after the predetermined number of races. After receiving the bets from the plurality of terminals, the controller stores the bet kind and the bet amount in the second memory. Then the controller executes a race and tallies the result thereof. In other words, the controller provides score to each of the plurality of characters corresponding to the ranking thereof, and accumulates score for each of the teams. Then, the controller determines the ranking of the teams based on the accumulated score for each race after a set of races, and provides award depending on the bet kind and the bet amount made by each of the plurality of terminals, based on at least any one of the ranking of each of the plurality of characters in each race and the ranking of each of the plurality of teams.

In a third aspect of the present invention, a gaming machine is provided including: a display for displaying images related to a racing game in which a set of a predetermined number of races is executed; first memory for storing a plurality of teams constituted of a predetermined plurality of characters which participates in at least any one of the predetermined number of races and being a target of a bet; an input device for accepting at least any one of: a first bet which is a bet on any one of the plurality of the teams; a second bet which is a bet on characters in each of the predetermined number of races; and a third bet which is a bet on a series of the teams, designating finishing places thereof after the predetermined number of races, and input a bet amount; second memory for storing, for each of the plurality of terminals, at least any one of the first bet, the second bet, and the third bet, and the bet amount; third memory for storing, for each of a plurality of the teams, a score provided to a plurality of the teams; and a controller for executing the predetermined number of racing games; in which the controller executes the following processing of: (a) storing at least any one of the first bet, the second bet, and the third bet, and the bet amount in the second memory; (b) after the end of each of the predetermined number of races, determining a score corresponding to a finishing order of the plurality of characters participating in the race, and storing the score in the third memory for each of the plurality of the teams; (c) after the predetermined number of races, determining a ranking of the teams based on a total score for each of the plurality of teams stored in the processing (b); and (d) providing an award based on: a ranking of the plurality of characters; a ranking of the teams determined in the processing (c); and a bet type and the bet amount stored in the second memory.

In the third aspect of the present invention, the controller can handle the similar processing as described in the first aspect.

In a fourth aspect of the present invention, a gaming machine is provided including: a display for displaying images related to a racing game in which a set of a predetermined number of races is executed; first memory for storing a plurality of teams constituted of a predetermined plurality of characters which participate in at least any one of the predetermined number of races and is a target of a bet; an input device for accepting at least any one of: a first bet which is a bet on any one of a plurality of the teams; a second bet which is a bet on characters in each of the predetermined number of races; and a third bet which is a bet on a series of the teams, designating finishing places thereof after the predetermined number of races, and input a bet amount; second memory for storing, for each of a plurality of terminals, at least any one of the first bet, the second bet, and the third bet, and the bet amount; third memory for storing, for each of the plurality of the teams, a score provided to the plurality of the teams; and a controller for executing the predetermined number of racing games; in which the controller executes the following processing of: (a) selecting a plurality of teams from the plurality of teams stored in the first memory, to show as options in the racing game; (b) displaying the plurality of characters and the plurality of the teams selected in the processing (a) on the display; (c) storing at least any one of the first bet, the second bet, and the third bet, and the bet amount in the second memory; (d) after the end of each of the predetermined number of races, determining a score corresponding to a finishing order of the plurality of characters participating in the race, and storing the score in the third memory for each of a plurality of the teams; (e) after the end of the predetermined number of races, determining a ranking of the teams based on the total score for each of the plurality of the teams stored in the processing (d); and

(f) providing an award based on: a ranking of the plurality of characters; a ranking of the teams determined in the processing (e); and a bet type and the bet amount stored in the second memory.

In the fourth aspect of the present invention, the controller can handle the similar processing as the second aspect.

In a fifth aspect of the present invention, a game control method is provided with a composition including: a display for displaying images related to a racing game in which a set of a predetermined number of races is executed; first memory for storing a plurality of teams constituted of a predetermined plurality of characters which participate in at least any one of the predetermined number of races and is a target of a bet; a plurality of terminal including an input device for accepting at least any one of: a first bet which is a bet on any one of a plurality of the teams; a second bet which is a bet on characters in each of the predetermined number of races; and a third bet which is a bet on a series of the teams, designating finishing places thereof after the predetermined number of races, and input a bet amount; second memory for storing, for each of a plurality of terminals, at least any one of the first bet, the second bet, and the third bet, and the bet amount; third memory for storing, for each of the plurality of the teams, a score provided to the plurality of the teams; a controller for executing the predetermined number of racing games; a communication network device for allowing intercommunication between the plurality of terminals and the controller, in which the method executed by the controller includes steps of: (a) receiving at least any one of the first bet, the second bet and the third bet, and the bet amount from the plurality of terminals and storing thereof in the second memory; (b) after the end of each of the predetermined number of races, determining a score corresponding to a finishing order of the plurality of characters participating in the race, and storing the score in the third memory for each of the teams; (c) after the end of the predetermined number of races, determining ranking of the teams based on a total score for each of the plurality of the teams stored in the processing (b); and (d) providing an award based on: a ranking of the plurality of characters; a ranking of the teams determined in the processing (c); and a bet type and the bet amount of each of the plurality of terminals.

In the fifth aspect of the present invention, the controller can handle the similar processing as described in the first aspect.

### BRIEF DESCRIPTION OF THE DRAWINGS

FIG. 1 is a flow chart showing the main part of the present invention;

FIG. 2 is a perspective view showing the gaming system according to a preferred embodiment of the present invention;

FIG. 3 is a diagram showing the configuration of a gaming system according to a preferred embodiment of the present invention;

FIG. 4 is a block diagram of a main controller of the gaming system according to a preferred embodiment of the present invention;

FIG. 5 is a perspective view illustrating the terminal device according to the preferred embodiment of the present invention;

FIG. 6 is a block diagram showing an outline of the terminal device according to a preferred embodiment of the present invention;

FIG. 7 is a diagram showing the main flow chart of a gaming system according to a preferred embodiment of the present invention;

FIG. 8 is a diagram showing a score table according to a preferred embodiment of the present invention;

FIG. 9 is a flowchart showing bet target team determination processing of FIG. 7;

FIG. 10 is a diagram showing bet target team determination table according to a preferred embodiment of the present invention;

FIG. 11 is a flowchart showing team result processing of FIG. 7;

FIG. 12 is a diagram showing a display example of the sub display device of the terminal device according to a preferred embodiment of the present invention;

FIG. 13 is a diagram showing a display example of the main display device according to a preferred embodiment of the present invention;

FIG. 14 is a diagram showing a display example of the main display device according to a preferred embodiment of the present invention; and

FIG. 15 is a diagram showing a display example of the main display device according to a preferred embodiment of the present invention.

### DETAILED DESCRIPTION OF THE INVENTION

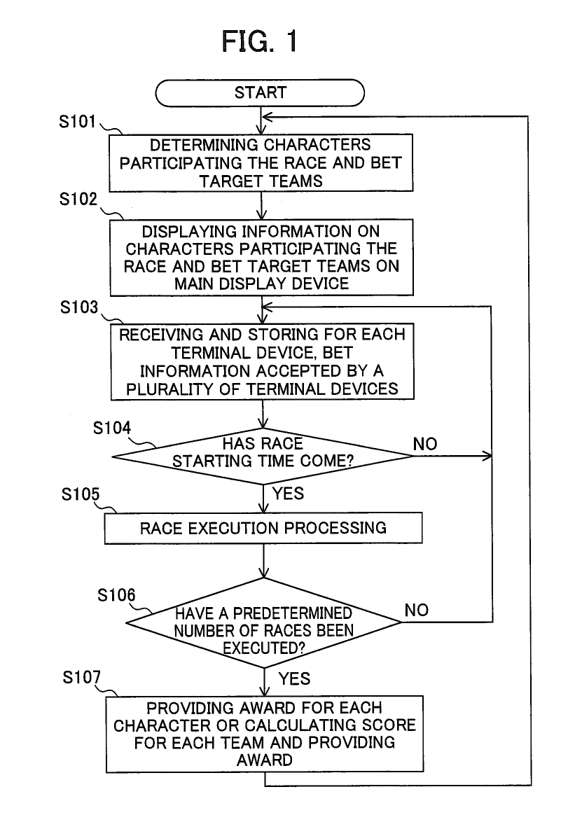

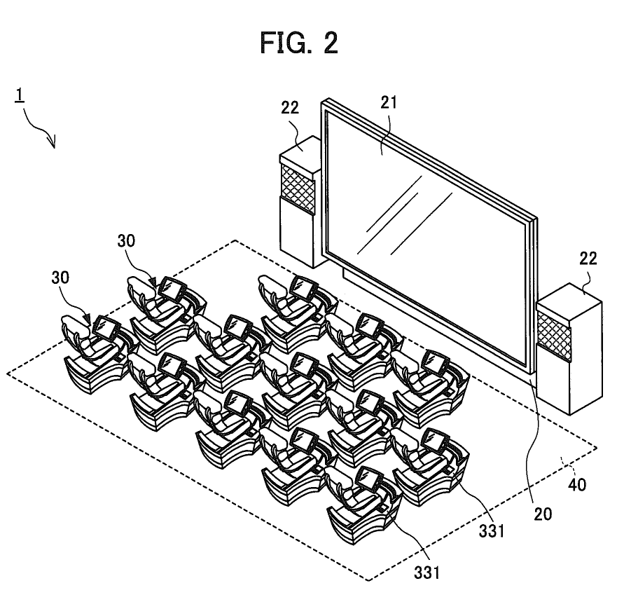

The main part of the present invention is described hereinafter with reference to FIG. 1. A main control unit 112, of a main controller 20 that performs the overall control the gaming system 1 according to the present invention, determines a plurality of characters participating in each of a set of races and a plurality of teams as a target of a bet (Step S101). In Step S102, the main control unit 112 displays the plurality of characters participating in a race and a plurality of the teams on a main display device 21 and/or a sub display device 34. In Step S103, the main control unit 112 receives from a plurality of terminal devices 30 bet and bet amount accepted thereby, and stores the same, for each terminal device 30, in a predetermined storage region in RAM 142 being second memory. In Step S104, the main control unit 112 determines whether a bet accepting period has elapsed or not. In the case of a YES determination, processing is advanced to Step S105, and in the case of a NO determination, processing is advanced to Step S103. In Step S105, a racing game is executed, and then processing advances to Step S106. In Step S106, the main control unit 112 determines whether the predetermined number of races in a set is executed or not. In the case of a YES determination, processing is advanced to Step S107, and in the case of a NO determination, processing is advanced to Step S103 for accepting bet for next race. In Step S107, the main control unit 112 calculates award for each of the plurality of characters and score for each team based on a result of the racing game, and provides award to each terminal device 30.

FIG. 1 is a perspective view showing an appearance of a gaming system 1 including a plurality of terminal devices 30. The gaming system 1 is a multi-player gaming system for a multi-player-type horse racing game, in which a plurality of players can participate, including a plurality of terminal devices 30 and a main controller 20, which is a controller having a large main display device 21.

The main controller 20 includes and controls the main display device 21 and speakers 22 installed on both sides of the main display device 21.

The main display device 21 is a large projector display device. The main display device 21 displays an image of a plurality of racehorses racing, a result of a race, and the like, in response to commands by the main controller 20. On the other hand, a sub display device 34 included in each terminal device 30 displays odds information for each racehorse, information related to a bet made by the player himself, and the like. It should be noted that a large projector display device as the main display device 21 is used in the present embodiment; however, the present invention is not limited thereto and any large monitor can be used.

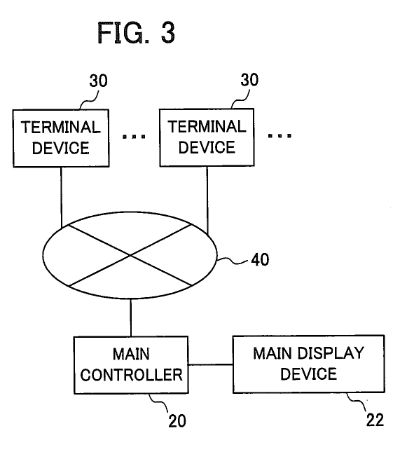

FIG. 3 is a schematic diagram showing a network of the gaming system 1.

In the gaming system 1, the main controller 20 and the plurality of terminal devices 30 can communicate with each other via a communication line and form a network 40. The main display device 21 is configured to be controlled by the main controller 20. The communication line can provide a wired or wireless connection.

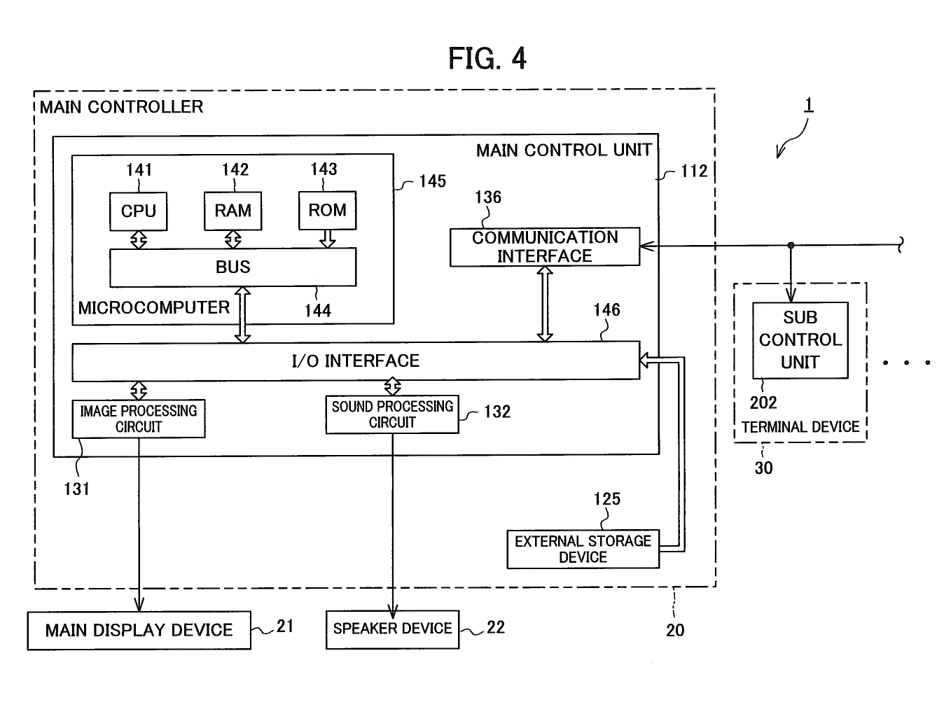

FIG. 4 is a block diagram showing the configuration of a main control unit 112 included in the main controller 20. Basically, the main control unit 112 is constituted mainly of a microcomputer 145 constituted of a CPU 141, RAM 142, ROM 143, and a bus 144 for data transfer therebetween. The RAM 142 and the ROM 143 are connected to the CPU 141 via the bus 144. The RAM 142 is memory for temporarily storing various data computed by the CPU 141. The ROM 143 stores various programs for the operations required for the control of the gaming system 1, data tables, and the like.

An image processing circuit 131 is connected to the microcomputer 145 via an I/O interface 146. The image processing circuit 131 is connected to the main display device 21 and controls the operation thereof.

The image processing circuit 131 is constituted of: program ROM; image ROM; an image control CPU; work RAM; a video display processor (VDP); video RAM; and the like (Not shown). The program ROM stores an image control program and various selection tables related to the display on the main display device 21. The image ROM stores pixel data for forming an image, such as pixel data for forming an image on the main display device 21. The image control CPU determines an image to be displayed on the main display device 21 from pixel data prestored in the image ROM based on a parameter defined by the microcomputer 145 and in accordance with an image control program prestored in the program ROM. The work RAM functions as a temporary storage device for executing the image control program by the image control CPU. The VDP generates image data according to the display content determined by the image control CPU, and outputs the same to the main display device 21. The video RAM functions as a temporary storage device to be used for forming an image by the VDP.

A sound circuit 132 is connected to the microcomputer 145 via the I/O interface 146. A speaker 22 is connected to the sound circuit 132. The speaker 22 generates various sound effects, BGM and the like for implementing various effects, based on a driving signal from the CPU 141 and with an output control by the sound circuit 132.

An external storage device 125 is connected to the microcomputer 145 via the I/O interface 146. The external storage device 125 operates similarly to the image ROM in the image processing circuit 131, and pixel data for forming an image, such as pixel data for forming an image on the main display device 21, is stored therein. Therefore, the image control CPU in the image processing circuit 131 selects an image to be displayed on the main display device 21 also from pixel data prestored in the external storage device 125.

A communication interface 136 is connected to the microcomputer 145 via the I/O interface 146. A sub control unit 202 of each terminal device 30 is connected to the communication interface 136. This allows two-way communication between the CPU 141 and each terminal device 30. The CPU 141 can transmit and receive instructions, requests, data and the like with respect to each terminal device 30 via the communication interface 136. Therefore, the main controller 20 of the gaming system 1 controls the progress of a horse racing game, in cooperation with each terminal device 30.

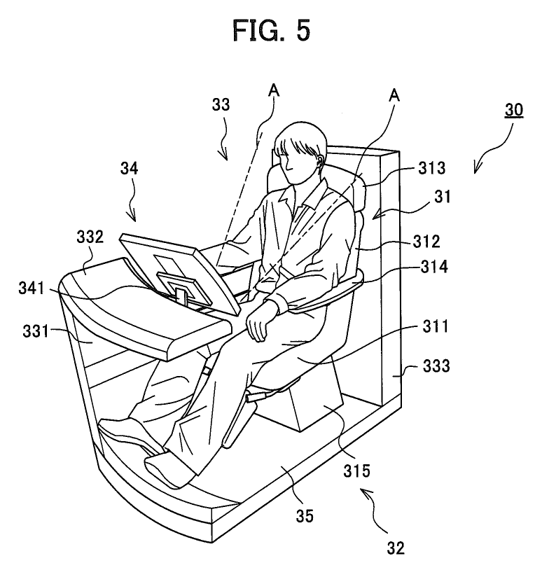

FIG. 5 is a perspective view showing an appearance of each terminal device 30. The terminal device 30 includes: a seat 31 on which a player can sit; an opening 32 formed on one of four lateral faces of the terminal device 30; a seat encircling portion 33 that covers three of four lateral faces of the terminal device 30 except for the lateral face having the opening 32; and a sub display device 34 installed on the seat encircling portion 33, in the front portion of the terminal device 30, that displays images related to the game.

The seat 31 includes: a seating surface 311 on which a player sits; a backrest 312 supporting the back of a player; a headrest 313 installed on top of the backrest 312; armrests 314 installed on both sides of the backrest 312; and a leg portion 315 fixed to the base portion 35.

The seat encircling portion 33 includes: a side unit 331 installed on an opposite face to the lateral face having the opening 32; a front unit 332 installed in the front portion of the terminal device 30; and a back unit 333 installed in the rear portion of the terminal device 30. This allows a player to sit on and get out of the seat 31 through the opening 32, in which the seat encircling portion 33 is not formed.

A medal slot into which medals corresponding to credits are inserted, a medal payout opening that pays out medals corresponding to credits, and the like are fixed on the side unit 331 (not shown). It should be noted that the gaming medium used in the present embodiment is medals; however, the present invention is not limited thereto. Examples of the gaming medium include coins, tokens, electronic money, or any equivalent valuable information such as electronic credit. In this case, credit can be paid out by a ticket printed out from a ticket printer 216 (described later).

The front unit 332 is a table having the base portion 35 and a substantially horizontal level surface, which is movably supported on the side unit 331, in the front portion of the terminal device 30. A player sitting on the seat 31 can put his legs into a space under the front unit 332.

The back unit 333 is integrated with the side unit 331 and constitutes a part of the seat encircling portion 33.

The sub display device 34 includes a supporting arm 341 supported by the front unit 332 and a rectangular liquid crystal monitor 342 for displaying, fixed at the distal end of the supporting arm 341. The liquid crystal monitor 342 is a so-called touch panel, and is provided at a position facing the chest of a player sitting on the seat 31. The liquid crystal monitor 342, which is a touch panel, serves as an input device used by a player to bet.

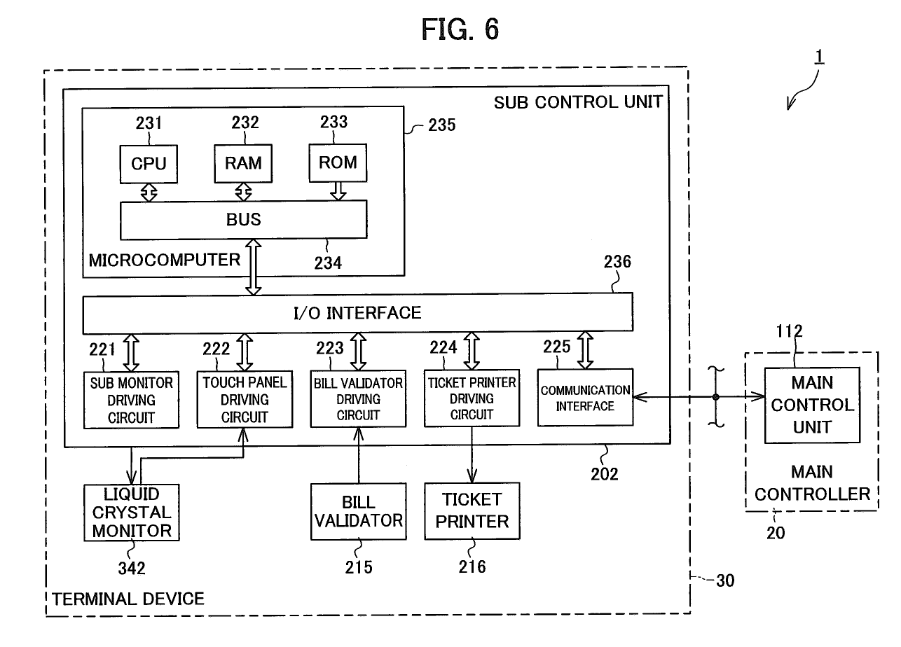

FIG. 6 is a block diagram showing the configuration of a sub control unit 202 included in the terminal device 30. The sub control unit 202 controls the terminal device 30 and basically is constituted mainly of a microcomputer 235 constituted of a CPU 231, RAM 232, ROM 233, and a bus 234 for data transfer therebetween. The RAM 232 and the ROM 233 are connected to the CPU 231 via the bus 234. The RAM 232 is memory for temporarily storing various data computed by the CPU 231. The ROM 233 stores various programs for the operations required for the control of the terminal device 30, data tables, and the like.

A sub monitor driving circuit 221 is connected to the microcomputer 235 via the I/O interface 236. A liquid crystal monitor 342 is connected to the sub monitor driving circuit 221. The sub monitor driving circuit 221 controls the operation of the liquid crystal monitor 342 based on a driving signal from the main controller 20.

A touch panel driving circuit 222 is connected to the microcomputer 235 via the I/o interface 146. A liquid crystal monitor 342 as a touch panel is connected to the touch panel driving circuit 222. An instruction, by a touching operation by a user, to the surface of the liquid crystal monitor 342 (touched position) is input to the CPU 231 based on a coordinate signal from the touch panel driving circuit 222.

A bill validator driving circuit 223 is connected to the microcomputer 235 via the I/O interface 236. A bill validator 215 is connected to the bill validator driving circuit 223. The bill validator 215 determines whether a bill or a bar coded ticket is valid or not. Upon reception of a valid bill, the bill validator 215 inputs the value thereof to the CPU 231 based upon the validating signal from the bill validator driving circuit 223. In addition, upon reception of a valid bar coded ticket, the bill validator 215 inputs the amount of credit and the like recorded therein to the CPU 231 based upon the validating signal from the bill validator driving circuit 223.

A ticket printer driving circuit 224 is connected to the microcomputer 235 via the I/O interface 146. A ticket printer 216 is connected to the ticket printer driving circuit 224. With an output control by the ticket printer driving circuit 224 based on a driving signal output from the CPU 231, the ticket printer 216 prints a bar code on a ticket, on which the data such as the credit amount stored in the RAM 232 are coded, and then prints out a bar coded ticket.

The communication interface 225 is connected to the microcomputer 235 via the I/O interface 236. The main control unit 112 of the main controller 20 is connected to the communication interface 225. This allows for two-way communication between the CPU 231 and the main control unit 112. The CPU 231 can transmit and receive instructions, requests, data and the like with respect to the main control unit 112 via the communication interface 225. Therefore, each terminal device 30 of the gaming system 1 controls the progress of a horse racing game, in cooperation with the main controller 20.

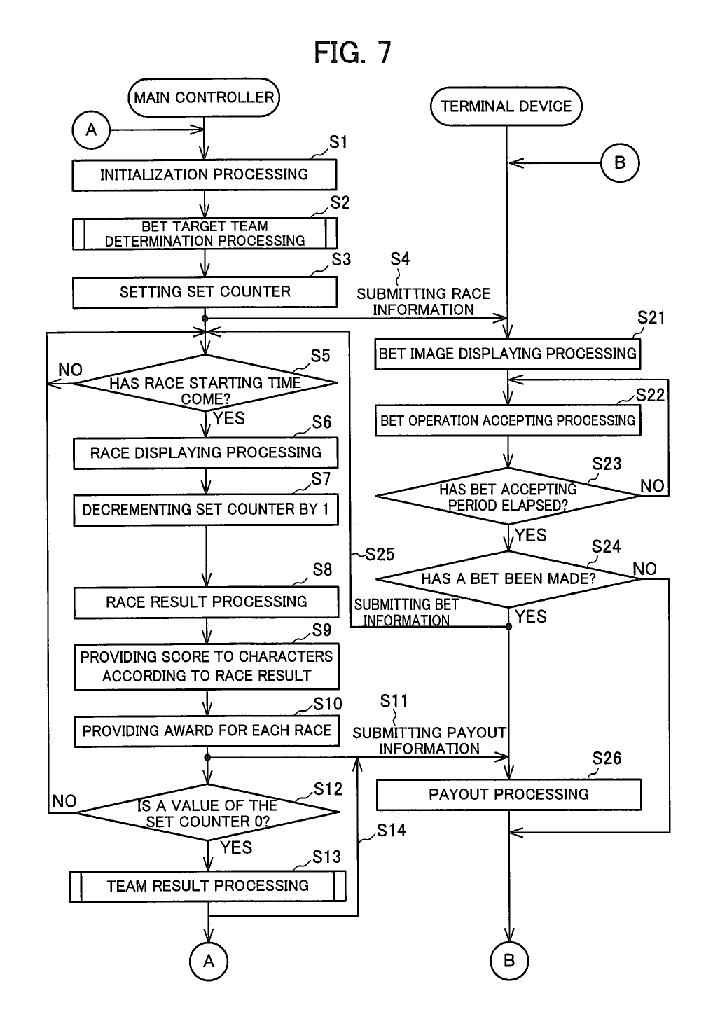

A flow of the operation of the gaming system 1 is explained hereinafter with reference to the flow chart shown in FIG. 7. It should be noted that all the terminal devices 30 similarly perform a game in cooperation with the main controller 20, although a single terminal device 30 is illustrated in FIG. 7.

The main controller 20 executes processing of Steps S1 to S14. Firstly, in Step S1, the main control unit 112 performs initialization processing, and then processing advances to Step S2. In this processing, the CPU 141 determines courses of a plurality of races in a set, characters participating in each race, starting time of each race and the like of the horse racing game, and reads data thereof from the ROM 143.

In Step S2, the main control unit 112 performs bet target team determination processing, and then processing advances to Step S3. In the bet target team determination processing, a team as a target of a bet is determined based on the characters participating in each race, which are determined in Step S1. In this processing, teams are determined for each set of races. In other words, all the characters participating in each race are members of different teams. After a set of races, ranking of teams is determined according to the result of the set of races. Details are described hereinafter.

In Step S3, the main control unit 112 sets a set counter, and then processing advances to Step S4. The set counter is a counter for determining if a set of races is performed. This processing sets a number of races as a value to the set counter. The number of races in one set is 3 in the present embodiment, thus a value “3” is set to the set counter.

In Step S4, the main control unit 112 transmits race information to each of the terminal devices 30, and then processing advances to Step S5. In this process, the CPU 141 transmits data regarding: courses for a set of races and a course for the present race; characters participating in each race; bet target teams and members thereof; starting time of each race; and the like, to each terminal device 30.

In Step S5, the main control unit 112 determines whether it is the time for starting the race. In a case where this determination is YES, processing advances to Step S6, and in a case where this determination is NO, Step S5 is repeated. More specifically, the CPU 141 repeatedly checks the clock time until the time for starting the race comes, and, at the time for starting the race, advances to Step S6.

In Step S6, the main control unit 112 performs race displaying processing, and then processing advances to Step S7. In this processing, the CPU 141 displays a race image on the main display device 21 and outputs sound effects and a voice from the speakers 22, based on data that is read from the ROM 143 in Step S1.

In Step S7, 1 is subtracted from the value of the set counter and then processing advances to Step S8. This processing means that a race is performed once.

In Step S8, the main control unit 112 performs race result processing, and then processing advances to Step S9. In this processing, the CPU 141 computes the payout for each terminal device 30 based on the finishing order of the characters that participated in the race, data regarding bet information received from each terminal device 30, and the like.

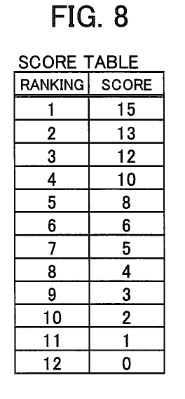

In Step S9, the main control unit 112 performs processing of providing a score to the characters participating in the race corresponding to the finishing order, and then processing advances to Step S10. This processing is to determine the ranking of teams, in the following Step S13. More specifically, a score corresponding to the finishing order is provided to the characters participating in the race based on the point table, later described in FIG. 8, and is stored for each team and for each character, in RAM 142 as the third memory.

In Step S11, the main control unit 112 performs payout information transmission processing, and then processing advances to Step S12. This processing transmits data regarding payout and the like, computed by the CPU 141 in Step S10, to the corresponding terminal device 30.

In Step S12, the main control unit 112 determines if the value of the set counter is 0. In the case of a YES determination, processing is advanced to Step S13, and in the case of a NO determination, processing is advanced to Step S5. This processing determines if all of the plurality of races in a set has been performed.

In Step S13, the main control unit 112 performs team result processing, and then processing advances to Step S14. In this processing, a ranking of teams is determined based on the score provided to the characters participating in the race. Details are to be hereinafter described.

In Step S14, the main control unit 112 performs payout information transmission processing, and then processing advances to Step S1. This processing transmits data regarding payout and the like, computed for each bet on teams by the CPU 141, to the corresponding terminal device 30.

On the other hand, each terminal device 30 executes processing of Steps S21 to S26. Firstly, in Step S21, the sub control unit 202 performs bet image display processing, and then processing advances to Step S22. In this processing, the CPU 231 displays the odds for each racehorse, past records thereof and the like on the liquid crystal monitor 342, based on the data sent from the main controller 20 in Step S4.

In Step S22, the sub control unit 202 performs bet operation accepting processing, and then processing advances to Step S23. In this processing, the CPU 231 enables touch operation by a player on the surface of the liquid crystal monitor 342 as a touch panel, starts accepting bet operation by the player, and changes images displayed thereon in accordance with the bet operation.

In Step S23, the sub control unit 202 determines whether a bet accepting period has elapsed or not. If the determination is YES, the flow advances to Step S24, and if NO, the flow advances to Step S22. More specifically, the CPU 231 repeatedly checks the clock time until a predetermined period is elapsed since the bet operation accepting processing is started in Step S22, and, once the predetermined period has elapsed, stop accepting the bet operation by the player and advances the flow to Step S24.

In Step S24, the sub control unit 202 determines whether a bet operation has been performed or not. If the determination is YES, the flow advances to Step S25, and if NO, the flow advances to Step S21. In this processing, the CPU 231 determines whether a bet operation has been performed in the abovementioned period in which the bet operation has been accepted.

In Step S25, the sub control unit 202 performs bet information transmission processing, and then processing advances to Step S26. In this processing, the CPU 231 transmits data regarding the performed bet operation to the main controller 20. After receiving data regarding bet operation from a plurality of terminal device 30, the main controller 20 stores each data, for each terminal device 30, in a predetermined storage region in RAM 142 as second memory.

In Step S26, the sub control unit 202 performs payout processing, and then processing advances to Step S21. In this processing, the CPU 231 pays out medals from the medal payout opening, based on the data regarding payout and the like sent from the main controller 20 in Step S8. In other words, the processing performed on the terminal device 30 is repeated for each race in the main controller 20.

The score table is described hereinafter with reference to FIG. 8. The score table is a table referenced in Step S31 of FIG. 10.

In the score table, predetermined scores are associated with ranks. For example, the score for the first place is 15. The score is thus provided to characters participating in the race according to the finishing order thereof.

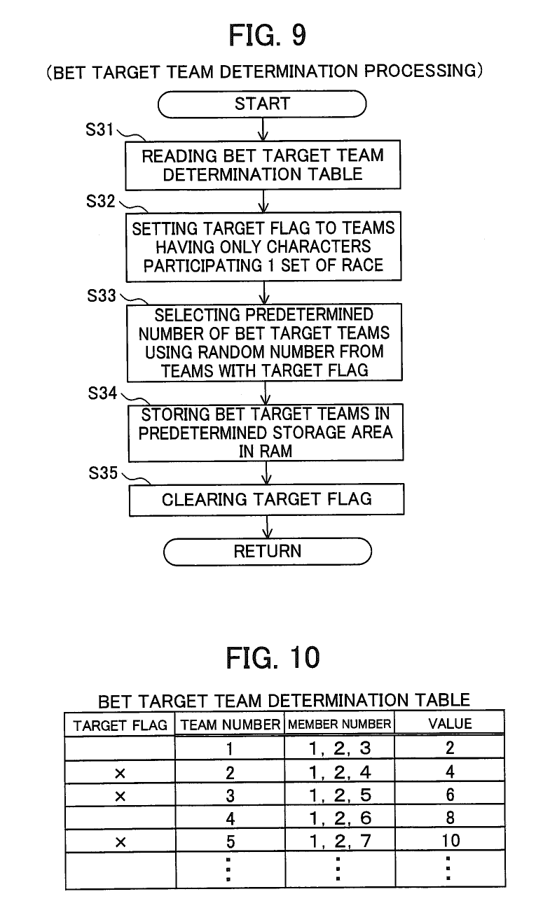

Bet target team determination processing is described with reference to FIG. 9.

In the bet target team determination processing, teams as a target of a bet are determined based on the characters participating in the race, which are determined in Step S2 of FIG. 7.

In Step S31, the main control unit 112 of the main controller 20 reads bet target team determination table (later described in FIG. 10) from a predetermined storage region in the ROM 143, which is a first memory, and then advances to Step S32.

In Step S32, the main control unit 112 sets a target flag, in the bet target team determination table, to teams including only characters participating in a set of races, and then processing advances to Step S33. The target flag is used for determining if the team is an option for bet target teams or not, in the processing of Step S33 (described later). Teams with the target flag are target of processing in Step S33.

In Step S33, the main control unit 112 determines bet target teams by generating random number, and then processing advances to Step S34. In the processing of Step 33, a predetermined number of bet target teams are determined based on the bet target team determination table read in Step S31 and the generated random numbers. More specifically, the main control unit 112 generates the same number of random numbers as the number of bet target teams, and assigns a bet target team for each random number from the teams with the target flag set in Step S32.

In Step S34, the main control unit 112 stores the bet target team being determined to the RAM 142, and then processing advances to Step S35.

In Step S35, the main control unit 112 clears the target flag set in Step S32, and then processing advances to Step S3 of FIG. 7.

The bet target team determination table read in Step S31 and referenced in Steps S32 and S33 is described with reference to FIG. 10.

In the bet target team determination table, a team number, a member number and a value are correlated to each other. The team number is a serial number for each of the teams that can be bet target. The member number is a number of each character participating in the race. The member numbers in the same column belong to the same team. A team is formed of an arbitral number of characters. In the present embodiment, three characters comprise a team. A “Target flag” column shows the target flags set in Step 32 of FIG. 9. For example, teams having “x” in the “Target flag” column in the bet target team determination table are target of the processing of Step S33.

It should be noted that a team does not have duplicate characters. In other words, multiple identical characters cannot be members of the same team.

Identical characters can belong to different teams in a set of races. In other words, different teams can have the same character at once. For example, team numbers 2 and 4 in the bet target team determination table can be selected as a bet target in the same set of races. The team number 2 has characters of 1, 2, and 4 as members and the team number 4 has characters of 1, 2, and 6 as members. In this case, the characters 1 and 2 are members of different teams in the same set of races.

To select a team, the main control unit 112 generates the same number of random numbers as the number of teams as a bet target. In the present embodiment, the number of bet target teams is 6. In this case, the main control unit 112 generates 6 random numbers.

Subsequently, the main control unit 112 subtracts the value associated with the team, sequentially from smaller team number, from the generated random number. In a case where the result is smaller than 0, the team having the value becomes a bet target team.

After the bet target team is thus determined for the first random number, a value is subtracted from the second random number, sequentially from the next team number having the target flag, until a negative number is obtained. The main control unit 112 thus determines bet target teams for the 6 random numbers.

For example, in a case where one of the generated random numbers is “5”, the main control unit 112 subtracts the number associated with a team, having the smallest team number and the target flag, therefrom. In the present embodiment, team number 2 and 3 have the target flag set. In this case, “4”, a value associated with the team number 2, is subtracted from the random number. The result is “1”, which is a positive number. Subsequently, the main control unit 112 subtracts “6”, a value associated with the next team having the target flag (team number 3), from the result of the subtraction “1”. In this case, a negative number is obtained and the team number 3 becomes a bet target team for the random number “5”. Next, the main control unit 112 subtracts a value associated with the team number 5, the next row having the target flag, from the second random number.

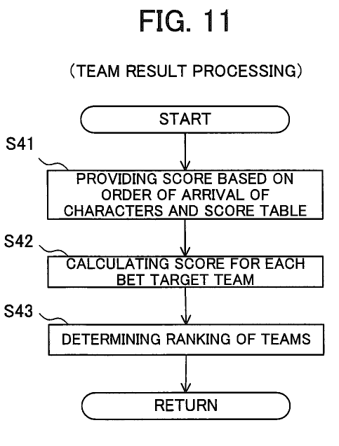

Team result processing is described hereinafter with reference to FIG. 11. The team result processing corresponds to Step S13 in FIG. 7.

In Step S41, the main control unit 112 reads the score provided to each character in Step S9, and then processing advances to Step S42.

In Step S42, the main control unit 112 sums the score provided to characters that are members of each bet target team in a set of races, and then processing advances to Step S43. More specifically, ranking of the teams is determined based on the total score of each team. For example, in a case where the team number 2 is one of the bet target teams, the main control unit 112 sums the score of characters 1, 2, and 4, which are the members of the team number 2. For example, in cases where the character 1 is in the first place, the character 2 is in the fifth place and the character 4 is in the tenth place, the score provided thereto is 15, 8, and 2, respectively. The sum total of the score is thus 25.

In Step S43, the main control unit 112 determines the ranking of teams based on the sum total of the score for each team calculated in Step S42, and then processing advances to Step S14 of FIG. 7. In the present embodiment, the team having the higher sum total of score is ranked higher.

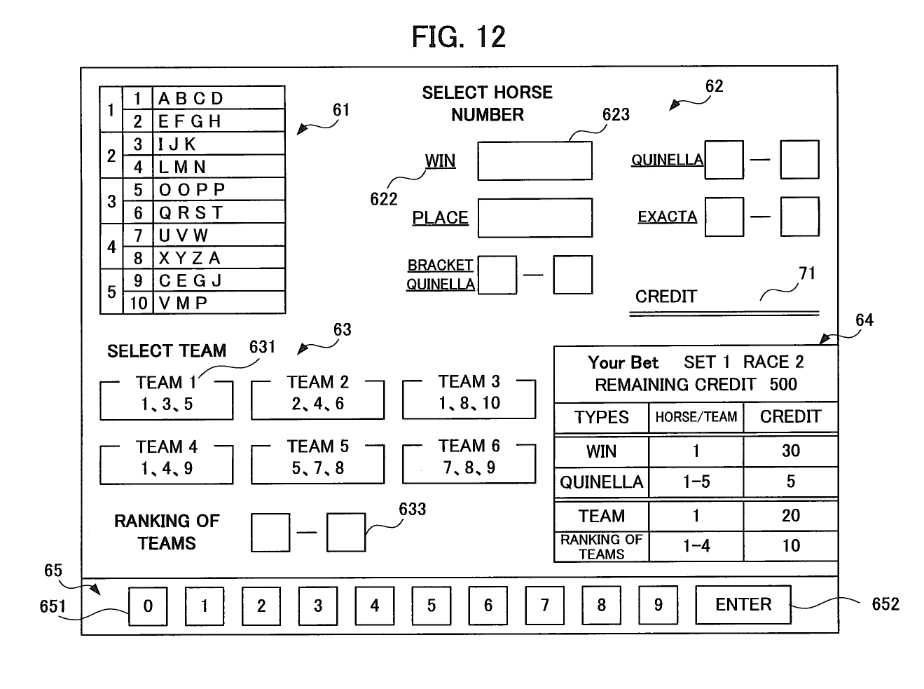

A display example of the bet window shown on the liquid crystal monitor 342 of the terminal device 30 is hereinafter described with reference to FIG. 12. The liquid crystal monitor 342 can be used as a touch panel, thus allowing a player to perform a bet operation by touching the touch panel according to the display thereon. In other words, the liquid crystal monitor and the touch panel are an input device of the terminal device 30.

The bet window is divided into 5 areas in the display example of FIG. 12. The first area 61 displays the character number, the post position, the character name and the like of the characters participating in the race. A player can select the character to bet on with reference thereto.

The second area 62 is an area for performing the second bet, betting on characters. An input area is provided for each bet type that can be chosen in the racing game. The bet types can include any bet type that can be chosen in the normal horse racing games, such as Win (to predict a character for the first place) and Quinella (to predict a combination of characters for the first and the second places). To input, a player touches a bet type to make the bet type be in a selected state. Subsequently, a player touches a character number or a character name displayed on the first area 61 to bet thereon. For example, to make a Win bet, a player first touches an item 622 “Win”, and then touches a character number or a character name displayed on the first area. This inputs the character number touched by a player in a column 623.

The third area 63 is an area for performing the first bet, betting on teams. Bet target teams and character number of members thereof are displayed on the third area 63. For example, a team 1 has character numbers 1, 3 and 5 as members. 6 bet target teams are thus displayed in the present embodiment. In a case of betting on a team, a player can specify a bet target by touching an area 631, in which a team to bet on is displayed. A player can input a bet amount by touching an ante input area 71, and then each number key 651 displayed in a numerical pad area 65.

A team order input area 633, used for betting on finishing order of teams, is provided in the third area 63. This area is used for making a bet on teams finishing in the first and the second places after a set of races. A player touches first the team order input area 633 and then the area 631 showing a team to bet on, to input the team number thereof in the team order input area. Alternatively, a player can also input the team number using the number keys 651 shown in the numerical pad area 65.

The fourth area 64 displays a list of bets made by a player. A player can check the number of races left in the set, the bets made, the credits remaining and the like, by looking at the fourth area 64.

The fifth area 65 is the numerical pad area. A player inputs bet amount in the fifth area 65. A player can input a bet amount by touching an ante input area 71, and then each number key 651 displayed in a numerical pad area 65. A player can confirm the input numerical value by touching an input key 652.

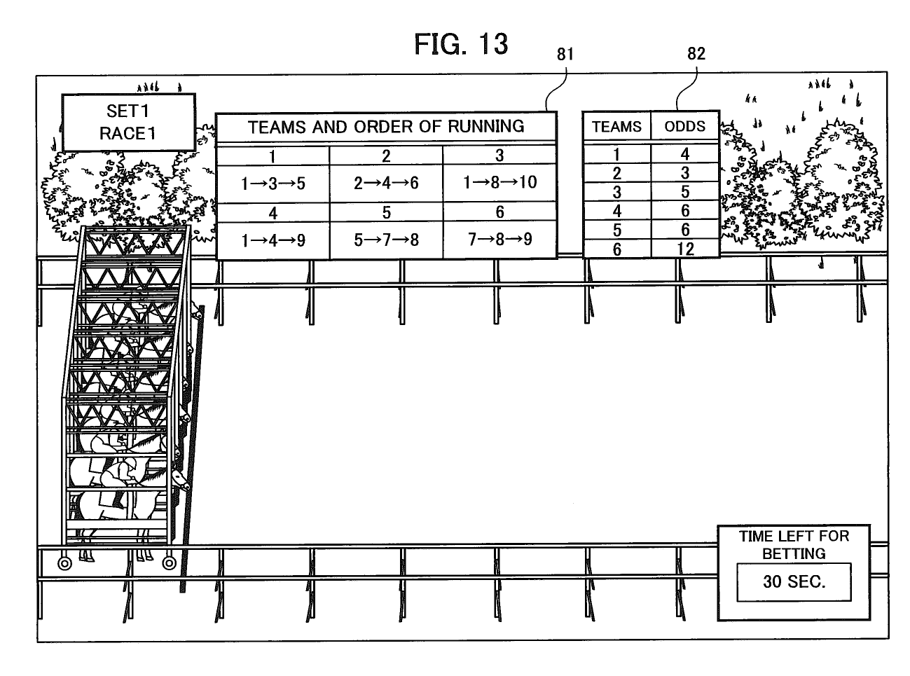

A display example of the main display device 21 is described with reference to FIGS. 13 to 15.

FIG. 13 is a display example of the main display device 21 before the first race of a set of races. According to FIG. 13, the main display device 21 displays a team table 81, which shows teams to be selected as bet target, and order of appearance of characters thereof in the race. The order of appearance in the race is shown by character numbers in each column for a team. More specifically, the leftmost number is the character appears in the first race; the number in the center is the character appears in the second race; and the rightmost number is the character appears in the third race.

To the left of the team table 81, a team odds table is displayed.

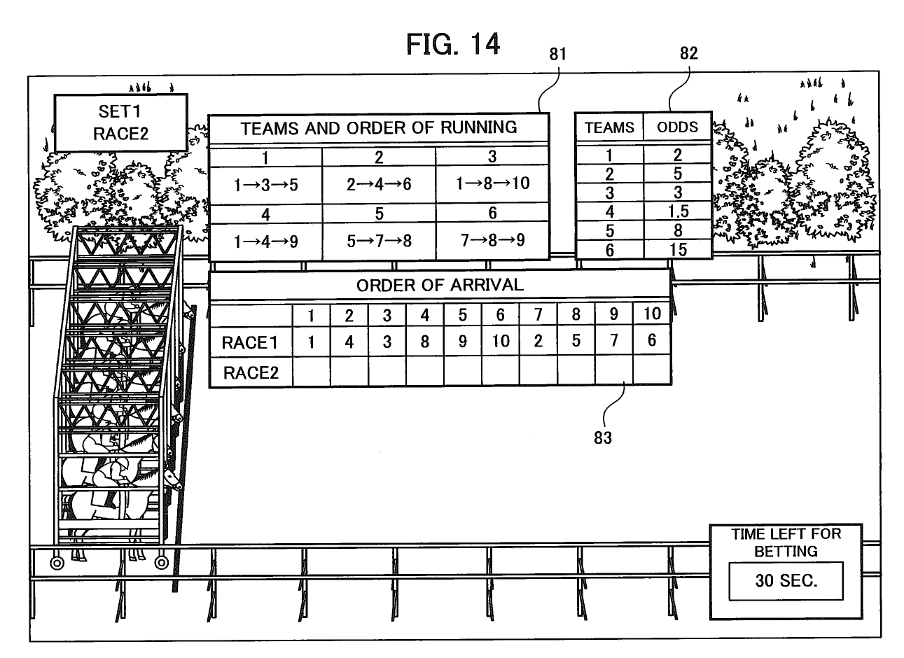

FIG. 14 is a display example of the main display device 21 before the second race of the set of races. According to FIG. 14, the main display device 21 displays a team table 81 and a team odds table 82 as in FIG. 13, and additionally a finishing order table 83 which shows the result of the first race. The finishing order table 83 shows the finishing order of each character in the first race.

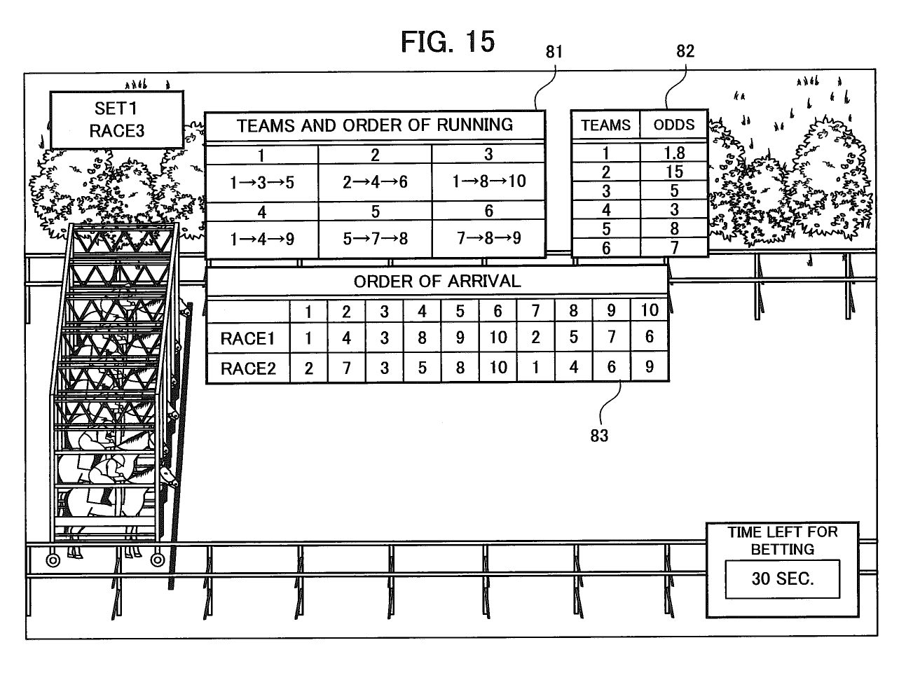

FIG. 15 is a display example of the main display device 21 before the third race of the set of races. According to FIG. 15, the main display device 21 displays a team table 81, an odds table 82 and a finishing order table 83, as in FIG. 14. In addition to the result of the first race, the finishing order table 83 also shows the result of the second race. This can help the player to predict the final winner team, and, give a player, who has already made a bet, an expectation that the team he bet on may win.

The present invention provides a gaming system, a gaming machine and a game control method as a racing game in which a predetermined number of races in a set takes place and a player can, in addition to betting based on a certain character among a plurality of characters participating in the race, bet on a team constituted of a plurality of characters. Thus, a relay-like racing game can be provided. This can provide a gaming system, a gaming machine and a game control method with various bet types and a higher chance of being rewarded, thus arousing interest and excitement of the player. In addition, racing game with various winning patterns can be provided, since only one strong character cannot make a team win.

In the present embodiment, a player can bet on teams constituted of a predetermined plurality of characters, in addition to a ranking of characters; however, the present invention is not limited thereto. For example, a configuration allowing only betting on teams is also possible. In addition, the number of members of a team is 3 in the present embodiment; however, the present invention is not limited thereto and a team can have less or more members.

In the present embodiment, a higher score is provided to a character of a higher rank, and the team having the higher sum total of score is ranked higher; however, the present invention is not limited thereto. For example, a lower score can be assigned to a character of a higher rank, and the team having the lower sum total of score can be ranked higher.

In the present embodiment, a bet can be made on a team of the first place and to teams of the first and the second places; however, the present invention is not limited thereto. For example, an embodiment is possible in which bet types such as Place and Quinella are provided, as in the bet on characters.

It should be noted that the gaming medium used in the present embodiment is medals; however, the present invention are not limited thereto. Examples of the gaming medium include coins, tokens, electronic money, or any equivalent valuable information such as electronic credit.

While the preferred embodiment of the present invention has been described above, it is apparent to one skilled in the art that various changes and modifications can be made without departing from the scope of the claims appended to this specification.

What is claimed is:

1. A gaming system comprising: a display for displaying images related to a racing game wherein a set of a predetermined number of races is executed;
first memory for storing a plurality of teams constituted of a predetermined plurality of characters which participates in at least any one of the predetermined number of races and is a target of a bet;
a plurality of terminals comprising an input device for accepting at least any one of:
a first bet which is a bet on any one of a plurality of the teams;
a second bet which is a bet on characters in each of the predetermined number of races; and
a third bet which is a bet on a series of the plurality of teams, designating finishing places thereof after the predetermined number of races, and input a bet amount;
second memory for storing, for each of the plurality of terminals, at least any one of the first bet, the second bet, and the third bet, and the bet amount;
third memory for storing, for each of a plurality of the teams, a score provided to each member of each of a plurality of the teams;
a controller for executing the predetermined number of racing games;
a communication network device for allowing intercommunication between the plurality of terminals and the controller,
wherein the controller executes the following processing of:
(a) receiving at least any one of the first bet, the second bet and the third bet, and the bet amount from the plurality of terminals and storing thereof in the second memory;
(b) after the end of each of the predetermined number of races, determining a score corresponding to a finishing order of the plurality of characters participating in the race, and storing the score in the third memory for each of the plurality of teams;
(c) after the predetermined number of races, determining ranking of the teams based on a total score for each of the plurality of teams stored by the processing (b); and
(d) providing an award based on: a ranking of the plurality of characters; a ranking of the teams determined in the processing (c); and a bet type and the bet amount of each of the plurality of terminals.

2. A gaming system comprising: a display for displaying images related to a racing game wherein a set of a predetermined number of races is executed;
first memory for storing a plurality of teams constituted of a predetermined plurality of characters, which participate in at least any one of the predetermined number of races and is a target of a bet;
a plurality of terminals comprising an input device for accepting at least any one of:
a first bet which is a bet on any one of the plurality of the teams;
a second bet which is a bet on characters in each of the predetermined number of races; and
a third bet which is a bet on a series of the teams, designating finishing places thereof after the predetermined number of races, and input a bet amount;
second memory for storing, for each of the plurality of terminals, at least any one of the first bet, the second bet, and the third bet, and the bet amount;
third memory for storing, for each of a plurality of the teams, a score provided to the plurality of the teams;
a controller for executing the predetermined number of racing games;
a communication network device for allowing intercommunication between the plurality of terminals and the controller,
wherein the controller executes the following processing of:
(a) selecting a plurality of teams from the plurality of teams stored in the first memory, to show as options in the racing game;
(b) displaying the plurality of characters and the plurality of the teams selected in the processing (a) on the display;
(c) receiving at least any one of the first bet, the second bet and the third bet, and the bet amount from the plurality of terminals and storing the same in the second memory;
(d) after the end of each of the predetermined number of races, determining a score corresponding to a finishing order of the plurality of characters participating in the race, and storing the score in the third memory for each of the plurality of the teams;
(e) after the predetermined number of races, determining ranking of the teams based on the total score for each of the plurality of the teams stored by the processing (d); and
(f) providing an award based on: a ranking of the plurality of characters; a ranking of a plurality of the teams determined in the processing (e); and
a bet type and the bet amount of each of the plurality of terminals.

3. A gaming machine comprising:
a display for displaying images related to a racing game wherein a set of a predetermined number of races is executed;
first memory for storing a plurality of teams constituted of a predetermined plurality of characters participating in at least any one of the predetermined number of races and being a target of a bet;
an input device for accepting at least any one of:
a first bet which is a bet on any one of the plurality of the teams;
a second bet which is a bet on characters in each of the predetermined number of races; and
a third bet which is a bet on a series of the teams, designating finishing places thereof after the predetermined number of races, and input a bet amount;
second memory for storing, for each of the plurality of terminals, at least any one of the first bet, the second bet, and the third bet, and the bet amount;
third memory for storing, for each of the plurality of the teams, a score provided to a plurality of the teams;
and a controller for executing the predetermined number of racing games;
wherein the controller executes the following processing of:
(a) storing at least any one of the first bet, the second bet, and the third bet, and the bet amount in the second memory;
(b) after the end of each of the predetermined number of races, determining a score corresponding to a finishing order of the plurality of characters participating in the race, and storing the score in the third memory for each of the plurality of the teams;
(c) after the predetermined number of races, determining a ranking of the teams based on a total score for each of the plurality of teams stored in the processing (b); and
(d) providing an award based on: a ranking of the plurality of characters; a ranking of the teams determined in the processing (c); and a bet type and the bet amount stored in the second memory.

4. A gaming machine comprising:
a display for displaying images related to a racing game wherein a set of a predetermined number of races is executed;
first memory for storing a plurality of teams constituted of a predetermined plurality of characters which participate in at least any one of the predetermined number of races and is a target of a bet;
an input device for accepting at least any one of:
a first bet which is a bet on any one of a plurality of the teams;
a second bet which is a bet on characters in each of the predetermined number of races; and
a third bet which is a bet on a series of the teams, designating finishing places thereof after the predetermined number of races, and input a bet amount;
second memory for storing, for each of a plurality of terminals, at least any one of the first bet, the second bet, and the third bet, and the bet amount;
third memory for storing, for each of the plurality of teams, a score provided to the plurality of teams;
and a controller for executing the predetermined number of racing games;
wherein the controller executes the following processing of:
(a) selecting a plurality of teams from the plurality of teams stored in the first memory, to show as options in the racing game;
(b) displaying the plurality of characters and the plurality of teams selected in the processing (a) on the display;
(c) storing at least any one of the first bet, the second bet, and the third bet, and the bet amount in the second memory;
(d) after the end of each of the predetermined number of races, determining a score corresponding to a finishing order of the plurality of characters participating in the race, and storing the score in the third memory for each of a plurality of the teams;
(e) after the end of the predetermined number of races, determining a ranking of the teams based on the total score for each of the plurality of the teams stored in the processing (d); and
(f) providing an award based on: a ranking of the plurality of characters; a ranking of the teams determined in the processing (e); and a bet type and the bet amount stored in the second memory.

5. A game control method for controlling a racing game executed by a gaming machine having:
a display for displaying images related to a racing game wherein a set of a predetermined number of races is executed;
first memory for storing a plurality of teams constituted of a predetermined plurality of characters which participate in at least any one of the predetermined number of races and is a target of a bet;
a plurality of terminal comprising an input device for accepting at least any one of:
a first bet which is a bet on any one of a plurality of the teams; a second bet which is a bet on characters in each of the predetermined number of races; and
a third bet which is a bet on a series of the teams, designating finishing places thereof after the predetermined number of races, and input a bet amount;
second memory for storing, for each of a plurality of terminals, at least any one of the first bet, the second bet, and the third bet, and the bet amount;
third memory for storing, for each of the plurality of the teams, a score provided to the plurality of the teams;
a controller for executing the predetermined number of racing games;
a communication network device for allowing intercommunication between the plurality of terminals and the controller,
wherein the method executed by the controller comprises steps of:
(a) receiving at least any one of the first bet, the second bet and the third bet, and the bet amount from the plurality of terminals and storing thereof in the second memory;
(b) after the end of each of the predetermined number of races, determining a score corresponding to a finishing order of the plurality of characters participating in the race, and storing the score in the third memory for each of the teams;
(c) after the end of the predetermined number of races, determining ranking of the teams based on a total score for each of the plurality of the teams stored in the processing (b); and
(d) providing an award based on: a ranking of the plurality of characters; a ranking of the teams determined in the processing (c); and a bet type and the bet amount of each of the plurality of terminals.
